(19) United States
(12) Patent Application Publication
(10) Pub. No.: US 2008/0288919 A1
(43) Pub. Date: Nov. 20, 2008

(54) Encoding of Symbol Table in an Executable

(75) Inventors: Stephen Hodges, Cambridge (GB); David Alexander Butler, Cambridge (GB); Rahul Balani, Los Angeles, CA (US); Shahram Izadi, Cambridge (GB)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/748,395

(22) Filed: May 14, 2007

(51) Int. Cl. G06F 9/44

(52) U.S. Cl. 717/106

(57) ABSTRACT

A method of compiling source code is described in which symbol information is retained in the optimized object code and the executable file. This symbol information is retained in the form of function calls which return memory locations and enable an application to query where variable or function data is stored and then access that variable or function data.

### COPYRIGHT NOTICE

A portion of the disclosure of this patent contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND

When compiling source code, the compiler assigns variables to registers or memory locations and when an executable file is created, the mapping information relating the symbol for a particular variable (i.e. the string which represents the variable, such as ‘current temperature’ or ‘balance’) and the memory location or register used to store the variable may be lost (especially for embedded applications). In order to debug code, which usually involves pausing the code and looking at the values of one or more variables, the code is compiled in a debug mode. This mode causes the generation of a symbol file which can be used by a debugging tool and a listing file which can be read by an application or by the user performing the debugging. This symbol file which is generated is in a format which is specific to the particular compiler used and therefore the debugging tool used needs to be compatible with the compiler. The choice of compiler used may be limited by the processor on which the code will run.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A method of compiling source code is described in which symbol information is retained in the optimized object code and the executable file. This symbol information is retained in the form of function calls which return memory locations and enable an application to query where variable or function data is stored and then access that variable or function data.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a flow diagram of a first example method of compiling source code;

FIG. 2 shows a first example flow diagram of a method of symbol look-up;

FIG. 3 is a flow diagram of a second example method of compiling source code;

FIG. 4 shows a second example flow diagram of a method of symbol look-up;

FIG. 5 shows a third example flow diagram of a method of symbol look-up;

FIG. 6 shows a fourth example flow diagram of a method of symbol look-up;

FIG. 7 shows a schematic diagram of elements of a modular development platform;

FIG. 8 shows a schematic diagram of the electrical connections between the elements of the modular development platform; and

FIG. 9 illustrates an exemplary computing-based device in which embodiments of the methods described herein may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

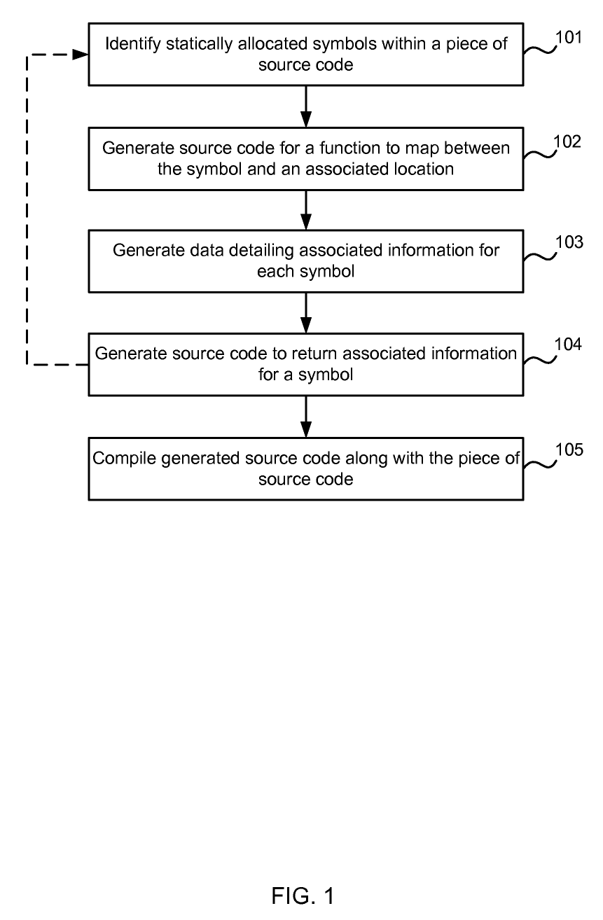

FIG. 1 is a flow diagram of a first example method of compiling source code (or source files) in which symbol information is retained in the optimized object code. The symbol information is also retained within the executable file such that at any point, the code (e.g. when running on an embedded device) can be queried using a simple host application to determine values of any variables used. This enables querying for debugging initially and also enables analysis of the operation of the code at any subsequent stage. This may be particularly beneficial where the code s running on an embedded device, but may be used for any code.

In addition to performing the standard compiling operations (not shown in FIG. 1), such as lexical analysis, parsing, optimization and code generation, the statically allocated symbols within a piece of source code are identified (block 101) and source code is generated for a function which maps between the symbol (e.g. ‘current temperature’) and a location associated with that symbol (block 102), which may be a memory or register location. Examples of statically allocated symbols include, but are not limited to, static local and global variables, static local and global register variables and functions. The location associated with a symbol may be the storage location of a variable or the address of the entry point of a function. The source code generated (in block 102) is arranged to return a location (e.g. a memory location) such as “x” in response to a function call such as “where(fred)”.

An example of such a generated piece of source code is provided below:

```
// Source file named “filename1.c”
int fred;
void main( ) {
    fred = 7;
    ....
}
// Generated source code to return memory location associated with
variables/functions
// declared in filename1.c
unsigned char ** filename1_where (char *variable) {
    if (!strcmp(variable, “fred”)) return (unsigned char **) (&fred);
}
```

Associated data is also generated (block 103) which may comprise the type information for each symbol (block 103), such as integer/string etc. This data may also include other information about the symbol, such as the size of the variable (e.g. the number of bytes of memory required), the number of elements in an array, the members of a struct (or structure), parameters for a function, the function return type, input/output variables for a function and their types etc. In some examples, this associated information may comprise a void where there is no associated information to return (e.g. where there is no type information associated with a particular symbol). Source code is then generated to return the data associated with a symbol (block 104). The source code generated (in block 104) is arranged to return associated information such as “integer, 4 bytes” in response to a function call such as “what(fred)”.

An example of this source code which is generated to return the data is shown below:

```
// Generated source code to return associated information with variables
declared in filename1.c
size_t filename1_what (char *variable, unsigned long int *type) {
  if (!strcmp(variable, “fred”)) {
    *type = TYPE_INTEGER;
    return sizeof(fred);
  }
}
```

The above example code suffices for variables of basic types like char (character), integer, float, double, string and their variations. However, for complex variables, such as instances of a struct or union, it may be required to access their members. The offsets of members within a structure are defined at compile time and vary from compiler to compiler. Thus, to keep the host application independent of the compiler, additional source code may be generated to return this information for the member of interest. In general, the source code can be specific to each individual source file. However, to optimize total size of the executable, a common function for all complex types defined in all the source files may be created. It is based on the observation that most of the code used common structures.

An example of use of this common function is described below: Consider the following complex type defined in the source file named filename1.c.

```
struct complex_type_t {
    int a;
    char b;
};
```

A function named get_type_data( ) is generated to return memory offset from base address and size and type information for each member of all complex types. It is placed in a separate file called “typedefs.c” in accordance with the optimization described above. Additionally, the types are mapped to an integer index so as to reduce code size, and enable faster execution. It is not necessary to use this optimization and the actual names may be used instead. In the example below, the complex_type_t structure is mapped to index zero.

```
size_t get_type_data (int type, char *member, unsigned long int
*member_type, size_t *member_size) {
  switch (type) {
    case 0: {
      struct complex_type_t *dummy = (struct
complex_type_t *)0x1000;
      if (!strcmp(member, “a”) {
        *member_type = TYPE_INTEGER;
        *member_size = sizeof(dummy->a);
        return ((size_t)&(dummy->a) −
(size_t)&(dummy->a));
      }
      if (!strcmp(member, “b”) {
        *member_type = TYPE_CHAR;
        *member_size = sizeof(dummy->b);
        return ((size_t)&(dummy->b) −
(size_t)&(dummy->a));
      }
    }
    default: break;
  }
  return 0;
}
```

The memory offset returned by the above function is used in conjunction with the base memory address of the variable obtained from filename1_where( ) function to get the exact location of the desired member variable. It is important to note that even if this function is made specific to each source file, its structure will remain the same as detailed above. It can be further split into two functions to get the location and associated data separately as in the filename1_where and filename1_what functions described previously. Thus, in similar spirit, the current implementation of filename1_where and filename1_what functions combines them into one function as shown below.

```
unsigned char **filename1_get_var_data(char *variable, unsigned
long int
*type, size_t *size) {
  if (!strcmp(variable, “fred”)) {
    *type = TYPE_INTEGER;
    *size = sizeof(fred);
    return (unsigned char **)(&fred);
  }
}
```

The process (blocks 101-104) may be repeated for other source files, or alternatively, all source files may be processed together. All the generated source code is then compiled along with the original piece of source code (block 105), for example using techniques which are native to any compiler. All the object code generated by the compiler, including that which was created from the generated source code, is then transformed into the executable code (e.g. by an assembler or linker, which may be called by the compiler or initiated separately).

Whilst this method may be used to identify all the statically allocated symbols within the source code (in block 101) and generate the appropriate source code (in blocks 102 and 104), in some examples only those statically allocated symbols that meet defined criteria may be identified (in block 101) and therefore the appropriate source code will not be generated (i.e. for symbols which are not identified in block 101, blocks 102-104 do not occur). For example, only those symbols which are flagged may be identified or only those symbols of a particular type (or types).

For static local variables, the source code for the mapping function is generated (in block 102) and included within the source file containing the static local variable. In order that this added source code does not affect the line numbering, which may cause confusion during debugging, the generated source code may be added at the end of the source file and/or an include statement may be used. A simple example code is shown below:

```
// Modified filename1.c after processing variables and complex types
defined in it.
int fred;
void main( ) {
    fred = 7;
    ....
}
#include “filename1_resolve_var.h”
// end of filename1.c
// filename1_resolve_var.h is generated and it contains the definition of
// filename1_get_var_data( ) as described above.
```

For global variables, the source code generated (in block 102) for the mapping function may be included within the source file containing the global variable (as described above) or the generated source code may be included within a separate, additional source file (e.g. a source file containing mapping functions for all global variables).

The associated data generated (in block 103) for each symbol may be included within the source file containing the relevant symbol (as described above), within the additional source file containing the mapping functions for the global variables, or within a further additional source file.

The source code generated (in block 104) to return the associated data (such as type data) for each symbol may be included within the source file containing the relevant symbol (as described above), within the additional source file containing the mapping functions for the global variables, within the additional source file containing the associated data or within a another additional source file.

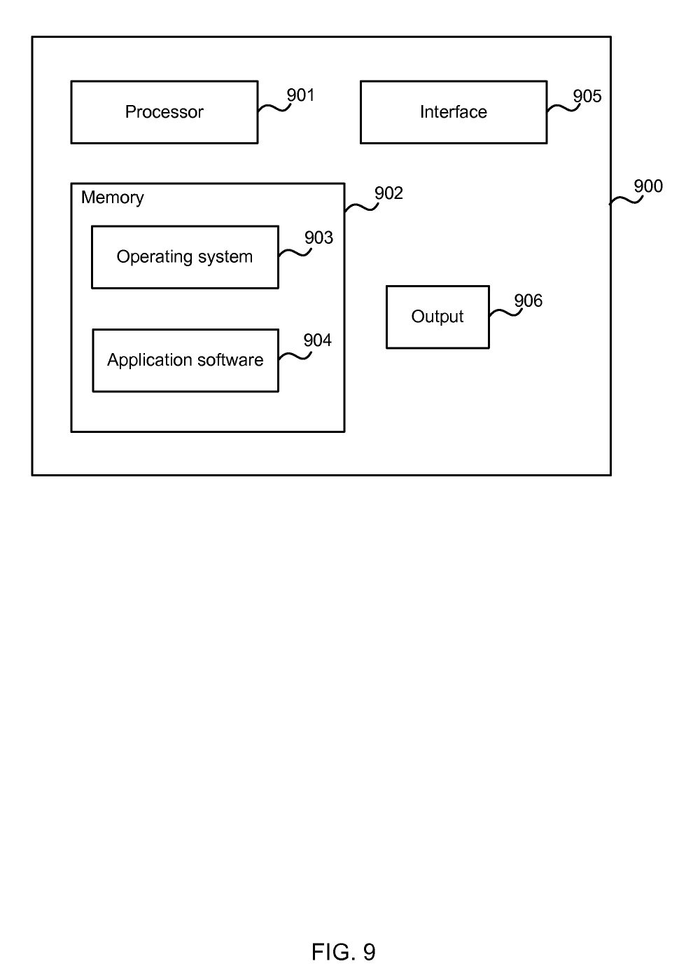

Whilst the compiler used to create the object code may be specific to a particular processor, (e.g. a particular processor which is to be used in an embedded device), the host application (also referred to as the host or the client application) used to query symbols (e.g. for debugging, interrogation etc) need not be specific to the compiler or to the processor because it does not need to be able to interpret symbol data in a particular custom format, i.e. it may be a generic remote entity. Instead the host need only call the functions created (e.g. as shown in FIG. 1) to identify the location and data associated with a symbol, e.g. the location where a variable is stored and type data for that variable. In an example the host may comprise a HyperTerminal application or a debugging tool, both of which may run on a computer (e.g. as shown in FIG. 9 and described below).

In reflection (also referred to as introspection) the executable application (generated from object code from block 105) itself calls the generated functions (e.g. generated as shown in FIG. 1) to query the variables/functions within the application itself.

The method describe above may be implemented using a pre-processor which performs blocks 101-104 and then the compiling (in block 105) may be performed using any compiler.

For embedded applications, it is often useful to have information on the software version, build date etc. By allowing constants to be queried or searched through the same interface as other variables may add ease of use (e.g. no need to read through code source files/header files). One way to incorporate this into the build is as static variables which have been initialized to a constant value. However, in some implementations, the preprocessing engine may also be arranged to capture specific (or even all) constants defined in the program. These do not normally have space allocated to them in memory, however the method (e.g. as implemented in a pre-processor) may pull the values out from the code in such a way as to be available to external or internal debugging functions (e.g. using a modified version of the methods described above). This would allow access not only to static variables, functions etc (which have addresses and types associated with them), but actual “#define” constants for example. These may be automatically placed into memory (so they would have an address and the method of FIG. 1 could operate as described above with and additional step of automatic placement into memory). In another example, these constants may be encoded into the automatically generated code so that accessing the symbol name returns the values, e.g. in the method of FIG. 1, the constants may also be identified in block 101, and in block 104 source code may be generated to return the values of those constants (in an equivalent manner to the additional information).

A simple example is shown below in which the piece of source code includes the following:

#define VERSION_MAJOR 1
#define VERSION_MINOR 2
#define DEFAULT_VOLUME 0.5
void init( void )
{
audioVolume = DEFAULT_VOLUME;
}

By applying the methods described above, this results in the following code:

// next 2 lines are auto-generated to place constant values as
readable SYMBOLS in memory
static uint autogen_VERSION_MAJOR 1
static uint autogen_VERSION_MINOR 2
// next line is auto-generated to place constant values as readable
SYMBOLS in memory
static float autogen_DEFAULT_VOLUME = 0.5;
#define VERSION_MAJOR 1
#define VERSION_MINOR 2
#define DEFAULT_VOLUME 0.5
void init( void )
{
audioVolume = DEFAULT_VOLUME;
}

This example shows that the newly created “const variables” may be treated in the symbol table as per other static variables.

Another option is to substitute the assignment/use of constants with references to these static variables and thus enable runtime adjustment of parameters initially thought to be constants through the debugging interface.

The methods described above may be implemented such that the variables, functions, constants etc which are identified (in FIG. 1) are compile-time selectable. For example, a user may be able to select between all variables or only those variables, functions, constants etc which are marked with a #PRAGMA directive.

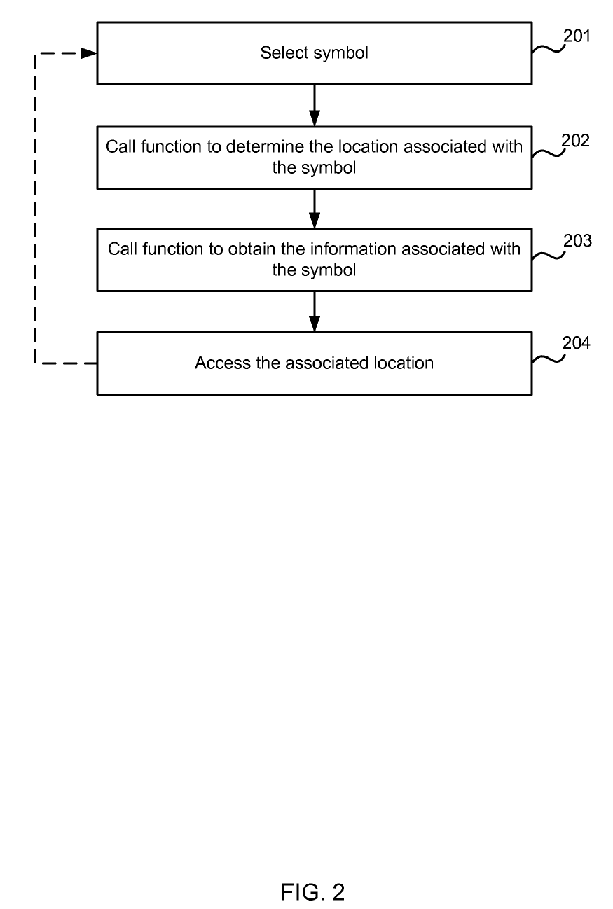

FIG. 2 shows a first example flow diagram of a method of symbol look-up which uses the functions generated as described above and shown in FIG. 1 and which may be performed by an application referred to herein as the ‘host application’ or the ‘host’. The host application may be a dedicated application or alternatively the host application may be used for other activities or functions. In order for the host application to obtain information on a symbol (e.g. ‘current temperature’), the application needs to know the symbol (‘current temperature’) and the look-up function(s). The host, having selected a symbol (block 201) may call two look-up functions: one to determine the location associated with the symbol (block 202) i.e. the function generated in block 102, and one to obtain the information associated with the symbol (block 203) i.e. the function generated in block 104. Where the symbol is a variable, the location may be the storage location of that variable and the associated information may be the variable's type. Having obtained this information, the host application can then read the relevant location (block 204) to obtain the value of the identified variable or to call the function (dependent on whether the symbol is a function or a variable). The process may then be repeated for additional symbols (e.g. if the value of another variable is required). Alternatively each step in the process may be repeated for multiple symbols before moving onto the next step.

Where functions are included in many different source files (e.g. because they are static local variables or because the functions for global variables have been included in this way), source code for a further function may be generated to extract details of all the generated functions in any source file. On the host side, a static local variable may only be identified by <filename, variable name>. This <filename, variable> identifier needs to be mapped to the right function on the embedded target. Hence, this extra function maintains a mapping from filename to the corresponding symbol look-up function. Thus, it is directly accessed by the host application to get desired information about the variable of interest. In other words, this extra function provides a common interface to access symbol look-up function corresponding to any file. A simple code example is shown below:

```
unsigned char **common_get_var_data(char *file, char *variable,
unsigned long int *type, size_t *size) {
  if (!strcmp(file, “filename1.c”)) {
    return filename1_get_var_data(variable, type, size);
  }
  if (!strcmp(file, “filename2.c”)) {
    return filename2_get_var_data(variable, type, size);
  }
}
```

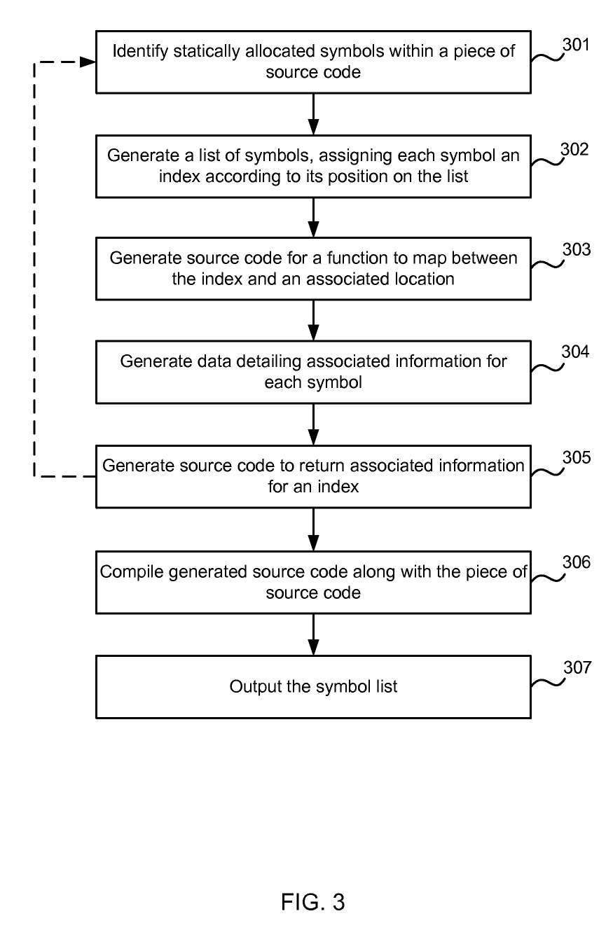

FIG. 3 is a flow diagram of a second example method of compiling source code (or source files) in which symbol information is retained in the optimized object code and the executable file. In this example, a reduced amount of symbol information is retained which reduces the amount of memory required in the embedded device and also reduces the volume of data being communicated between the embedded device and the host application, as described below.

The statically allocated symbols within a piece of source code are identified (block 301) and a list of symbols is generated, with each symbol being assigned an index according to its position on the list (block 302). For example, considering a list of variables: date, time, temperature, the variable ‘date’ is assigned an index 1, ‘time’ an index 2 and ‘temperature’ an index 3. Source code is generated for a function which maps between the index for a symbol and an associated location for that symbol (block 303). Data, such as type data, for each symbol is generated (block 304) along with source code for a function which returns the associated data for a symbol referenced by its index (block 305). As with FIG. 1, this process may be repeated for different source files or several source files may be processed at the same time. The generated source code is compiled along with the piece of source code (block 306) to output object code and the symbol list is also output (block 307). The symbol list may be in any suitable format, such as text or CSV or any other format which can be read by the host application. All the object code generated by the compiler, including that which was created from the generated source code, is then transformed into the executable code (not shown in FIG. 3).

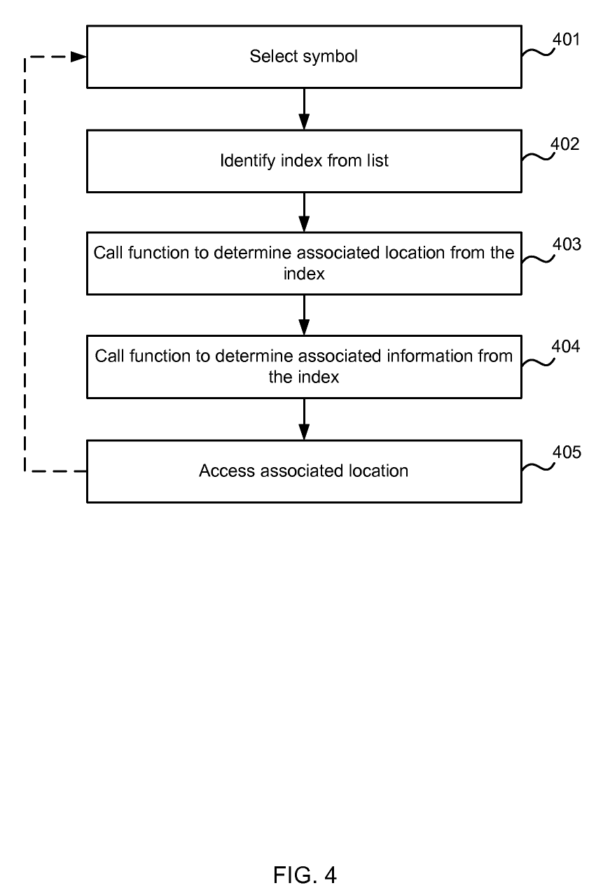

FIG. 4 shows a second example flow diagram of a method of symbol look-up which uses the functions and symbol list generated as described above and shown in FIG. 3. In this example, the host application has access to the symbol list (which was output in block 307) and therefore communicates the index to the embedded device (or to wherever the executable is running) rather than the symbol itself, which reduces the amount of data being communicated (e.g. communicating ‘1’ rather than ‘current temperature’ uses fewer bytes). A symbol is selected (block 401) by the host and the index for the selected symbol is identified from the list (block 402), which may be stored locally. A function is called to determine a location associated with the index (block 403) i.e. a function generated in block 303, and another function is called to determine associated information for the same symbol (block 404) and again the function call references the index instead of the symbol. Having this information, the host accesses the identified location (block 405) to obtain the value of the variable identified or to call a function (where the symbol is a function. The process may be repeated to determine the values of other variables or to call other functions if required.

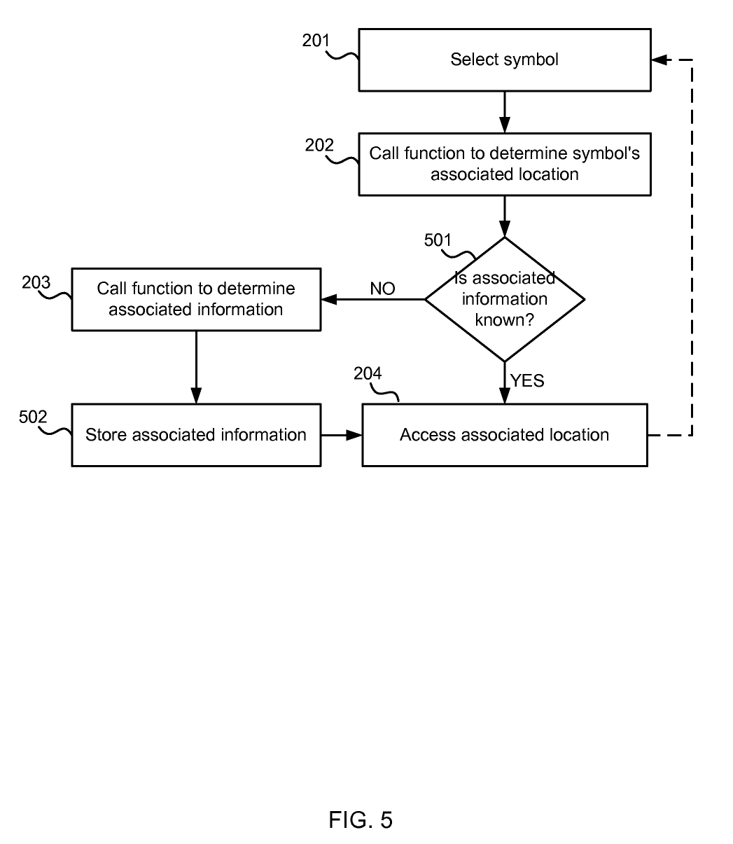

In some examples, a host may seek to determine the value of a particular variable (or other symbol) more than once, even if the calls are made over a long period of time (e.g. once during debugging and then one or more times during operation of the executable code). By using a slightly more sophisticated host, the amount of data transferred between the host and the embedded device (or other device where the executable is running) can be reduced, as shown in FIG. 5. In this example, the host determines whether the identified symbol's associated data is already stored at the host (block 501, e.g. type data where the symbol is a variable) and if it is, the function call to obtain the associated information is avoided. If however, the associated data is not already known to the host (as determined in block 501), the function call is made to obtain the data (block 203) and the data is stored by the host (block 502). As a result, the call for the associated data for any particular symbol may be made once, when that symbol is first queried, rather than every time the embedded device (or other device where the executable is running) is queried for the value of a variable or to call a function (where the symbol is a function).

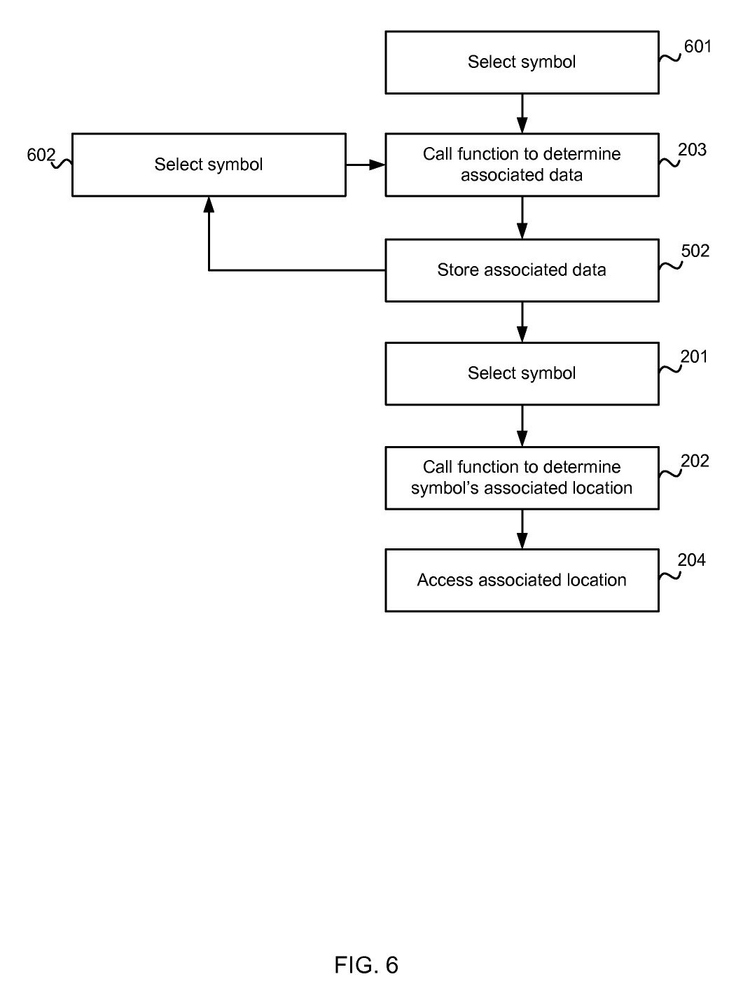

In another example, the host may extract all the associated information from the embedded device (or other device where the executable is running) initially, for example before deployment or the first time that the host queries the device, and then does not need to call the function to determine a symbol's associated data again, as shown in FIG. 6. In this example, the host selects a symbol (block 601) and calls the function to obtain the associated data for that symbol (block 203). The data is stored (block 502) and the next symbol is then selected (block 602) and the process (blocks 203, 502 and 602) is repeated until the associated information for each symbol has been stored. Subsequently, a symbol may be selected (block 201) and a function called to identify the associated location (block 202) which can then be accessed (block 204) to obtain the current value of the variable or to call a function (where the symbol is a function). In a further example, instead of blocks 601, 203, 502 and 602, a different function may be called which returns the associated data for all symbols within the executable code.

Whilst FIGS. 5 and 6 are based on FIG. 2, it will be appreciated that in other examples, FIG. 4 may be modified similarly. In further examples, the associated location for each symbol may be cached in addition to, or instead of, the associated information and again this location data may be cached after it has been initially requested (in a corresponding manner to that shown in FIG. 5) or all the location information may be accessed initially (in a corresponding manner to that shown in FIG. 6).

Caching of type and/or location information at the host, as shown in FIGS. 5 and 6 and described above, may be beneficial where the communication link between the embedded device is narrowband (e.g. via Short Message Service (SMS) messages) and/or expensive.

Whilst the above examples show two separate function calls, one for location and one for associated information, in further examples, these function calls may be nested, such that, for example, the function to obtain the associated location includes a further function call to obtain the associated information for the particular symbol.

The examples above show the generation of pure functions (e.g. as shown in FIG. 1), however in other examples, the generated functions (which may also be referred to as ‘auto-generated functions’) may be actual tasks (or threads) or pure functions which are bound to specific tasks or threads which are accessible from remote entities (for example). An example of this is a CLI (command line interpreter) process of an embedded application which might comprise stubs to bind the auto-generated functions enabling users to type queries etc.

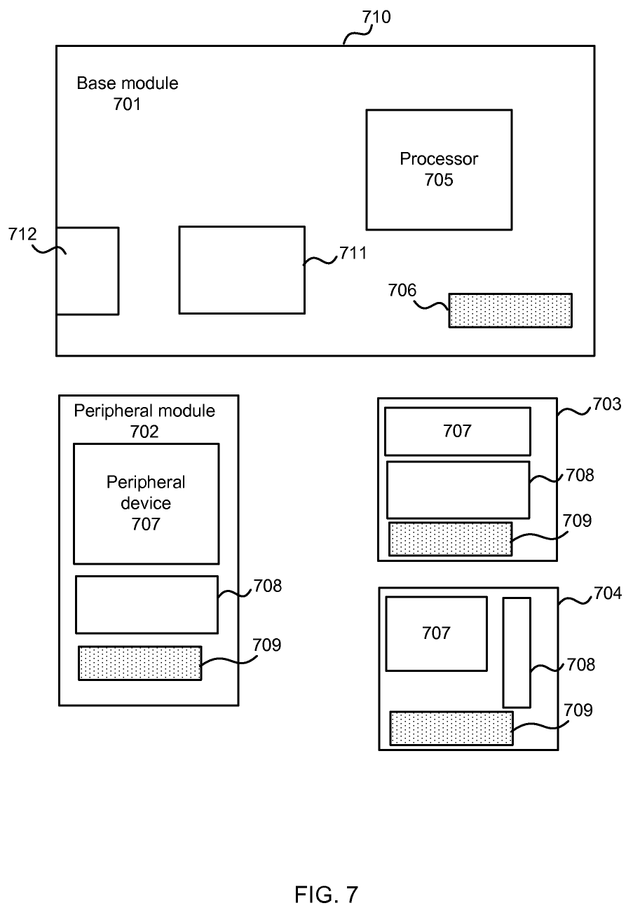

The methods described above may be used in compiling source code for a prototype embedded device, where the prototype is created using a modular development platform as shown in FIG. 7 and described below. The modular development platform is described in co-pending US Patent Application entitled ‘Embedded System Development Platform’ filed on the same day as this application and this application is incorporated herein by reference. The symbol look-up methods (e.g. as shown in FIGS. 2 and 4-6 and as described above) may then be used to interrogate the embedded device, either as part of a debugging process or at any stage in the operation of the device.

FIG. 7 shows a schematic diagram of elements of such a modular development platform, including a base module 701 and a number of peripheral modules 702-704. Each module is small (e.g. the base module 701 may be approximately 34 mm×51 mm) and can be connected together physically and electrically, to form a particular complete embedded device.

The base module 701 comprises a processor 705 such as a microcontroller, microprocessor or any other suitable type of processor. The base module 701 also comprises a header 706 or other connector which is used to electrically connect the base module to one or more peripheral devices. The processor and header may be mounted on a PCB 710 (such as a multi-layer PCB) or any other suitable base substrate. The substrate used may, as required by the application, be substantially rigid or flexible. The base module may include additional elements, such as a battery 711 (e.g. a lithium-ion battery), additional connectors 712 (e.g. a mini-USB connector), connectors, sockets, components, circuitry etc. The additional connector(s) 712 may be used to provide power to the module, to re-program the processor and/or in debugging the device. The base module may also comprise a second battery for maintaining the real time clock (e.g. as a back up battery). In an example, the base module may comprise an ARM7 microcontroller with a USB interface, real time clock and power regulation (including a lithium-ion battery charger) and the USB connection (via connector 712) may be used to re-charge the lithium-ion battery 711. In other examples, the battery (or an additional battery) may be provided as a peripheral module.

The modular development platform may include many different peripheral modules, each comprising a peripheral device 707, an interface element 708 and a header 709 or other connector which is used to connect the peripheral module to the base module and/or other peripheral modules. The interface element 708 is designed to interface between the signals received via the header 709 and the peripheral device 707 and may comprise a microcontroller or other processor. The interface element may be arranged to manage the powering down of the peripheral device 707 when not in use and the wake up of the peripheral device when required. The interface element may also be arranged to control the communication from the peripheral to the base module. A peripheral module may also include additional elements, such as a battery, interfaces, connectors, sockets, components, circuitry etc.

The peripheral modules may be powered from the base module over a bus (described in more detail below). Alternatively, or in addition, peripheral modules may include a battery. Where a peripheral module requires high currents (e.g. >0.5A, for example a GSM modem) a local battery may be provided as, dependent on the bus design, the current over the bus may be limited. Where a peripheral module includes a battery, this may provide power just to that peripheral module, or in some examples, the battery may also provide power to the base module and/or to other peripheral modules. Where batteries are provided on peripheral modules, these may be rechargeable and in some examples, the recharging may be performed over the bus with a single recharging point provided on the base module (e.g. connector 712).

The peripheral devices 707 may themselves comprise modules, for example which include a microcontroller and expose their functionality through an asynchronous interface such as UART (Universal Asynchronous Receiver Transmitter i.e. RS232 serial). Examples of peripheral devices include, but are not limited to, a GSM/GPRS/3G modem, a Bluetooth transmitter/receiver/transceiver, a GPS receiver, a WiFi module, a ZigBee™ module, memory modules (e.g. Flash memory), a VGA camera, a display, a touch sensor, an accelerometer, a magnetometer and basic I/O for LEDs, servers, buzzers etc. Additional processors may also be provided on a peripheral module. Further inputs to and/or outputs from the processor and communications devices may be provided by peripheral modules.

By using a well defined interface, additional peripheral modules can be developed as required without requiring modification of the base module or any other peripheral modules (i.e. it is a self-contained task). Additionally, by using a well-defined interface, this assists in managing the complexity of both the hardware and the firmware.

Whilst in FIG. 7, the interface elements 708 on the peripheral modules 702-704 are shown separately from the peripheral devices 707 themselves, in some examples the peripheral devices and the interface elements functionality may be integrated into a single device.

As described above and shown in FIG. 7, each module may comprise a header 706, 709 or other electrical connector (e.g. a 0.05″ or 1.27 mm pitch connector or header) to enable the modules to be electrically connected together and these headers may, in some examples, be used to physically connect modules together. In an example, a 0.05″ or 1.27 mm pitch 2×5 way connector or header may be used. The modules may be electrically connected together either board-to-board, board-ribbon cable-board or via one or more flexible or rigid mid-plane PCBs. In another example, a flexible PCB may be used instead of a ribbon cable.

The electrical interconnect between modules is selected to be reasonably high speed (e.g. 10-20 Mhz or faster than I²C which runs at 400 kbps) but only use a small number of wires (e.g. ≦10 wires in some examples). Whilst interconnects requiring large numbers of wires could be used, this would require larger connectors/headers on each module and this would limit the minimum size of a module and hence impact the compactness of the assembled device. Smaller cables are also easier to route between modules and therefore use of larger cables may also impact the compactness of the device because of the space required to route cables.

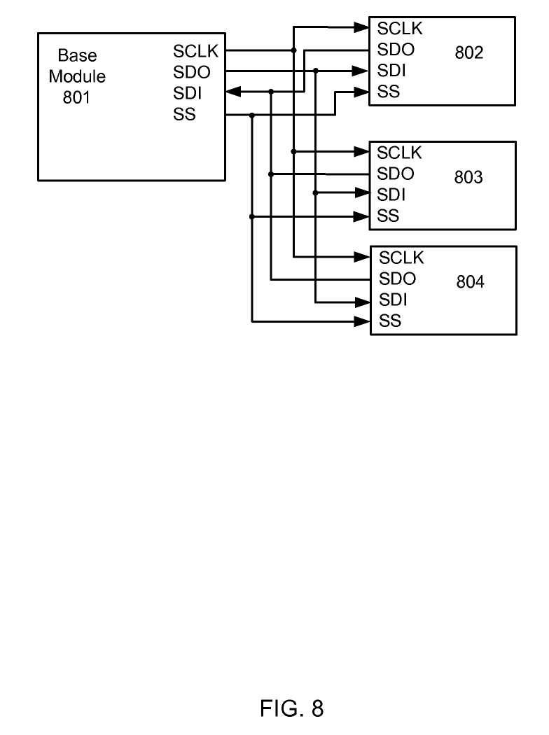

In an example, the interconnect may be based on SPI (serial peripheral interface) or a variant of SPI called Microwire. However, as standard SPI requires a dedicated wire for each peripheral on the bus, this limits the number of peripherals which may be used. Therefore a modified scheme may be used in which an addressing portion (such as an addressing byte) is sent at the beginning of each packet of information and this is read and interpreted by the interface element 708 on each peripheral to determine whether the packet of information is intended for that peripheral. The addressing portion may identify a single peripheral device or in some examples multicast addressing may be enabled such that more than one peripheral device may be identified within an addressing portion (e.g. to enable a signal to be sent which causes multiple peripheral modules to go to sleep). The interconnect comprises a daisy-chained serial bus such that signals pass from the base module 701, 801 to each of the peripheral modules 702-704, 802-804 in turn, as shown in FIG. 8. The modified SPI bus comprises three logic signals: serial clock (SCLK) which is output by the base module, serial data in (SDI) and serial data out (SDO). The SDI and SDO lines may alternatively be named master output, slave input (MOSI) and master input, slave output (MISO). The slave select (SS or chip select) signal is not used as it would be in a standard SPI bus as the peripheral module is selected by means of the addressing byte, as described above. There may still be a slave select line which causes each peripheral to listen (on its SDI) for a packet of information. In other examples, the SS may be omitted and a protocol used to determine when the peripheral modules listen for packets of information (e.g. for a finite time after a rising edge). Open collector logic (or equivalent) may be used to control which peripheral is able to communicate with the base module at any time.

In order to enable debugging of an assembled device, an interface on the processor 705 (e.g. a UART interface) on the base module 701 may be connected to a connector 712 (e.g. a mini-USB connector) via a suitable protocol converter chip (not shown in FIG. 7). This enables the device to be connected to a PC over USB and the debugging output will be available on the PC. If the processor 705 has more than one interface which may be used in debugging (e.g. more than one UART interface), these may be multiplexed onto the same USB channel (e.g. using a multiplexer) so that the required channel may be selected (e.g. via the PC) during debugging. The host application may be run on the PC and interrogate the device using one of the methods described above.

During operation of the assembled device, the same connection (e.g. USB connection) may be used to interrogate the device, or alternatively an alternative communication channel may be used, such as a Bluetooth link where the assembled device includes a Bluetooth peripheral module or via SMS where the assembled device includes a GSM (or other cellular telephony) modem peripheral module.

FIG. 9 illustrates various components of an exemplary computing-based device 900 which may be implemented as any form of a computing and/or electronic device, and in which embodiments of the methods described above may be implemented.

Computing-based device 900 comprises one or more processors 901 which may be microprocessors, controllers or any other suitable type of processors for processing computing executable instructions to control the operation of the device in order to compile source code and/or query an embedded device (or other device) as described above.

The computer executable instructions may be provided using any computer-readable media, such as memory 902. The memory is of any suitable type such as random access memory (RAM), a disk storage device of any type such as a magnetic or optical storage device, a hard disk drive, or a CD, DVD or other disc drive. Flash memory, EPROM or EEPROM may also be used.

The memory may be arranged to store platform software comprising an operating system 903 or any other suitable platform software may be provided at the computing-based device to enable application software 904, which may also be stored in the memory, to be executed on the device. The application software may comprise the compiler and/or the host application, as described above. The memory may be further arranged to store data received from the embedded device, such as associated information (e.g. in block 502), a symbol list, associated location data and symbol data.

The computing-based device 900 further comprises one or more interfaces 905 for communicating with external devices, such as an embedded device. The interface may be a serial interface, such as USB or RS232 or in another example the interface may be a network interface. The interface may be arranged to communicate wirelessly (e.g. via Bluetooth or WiFi) or over a wired link (e.g. a USB cable).

An output 906 may also be provided such as an audio and/or video output to a display system integral with or in communication with the computing-based device. The display system may provide a graphical user interface or other user interface of any suitable type although this is not essential.

Although the present examples are described and illustrated herein as being implemented in a device as shown in FIG. 9, the device described is provided as an example and not a limitation. As those skilled in the art will appreciate, the present examples are suitable for application in a variety of different types of computing systems.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person. Elements from any of the examples described above may be combined with elements of any of the other examples to provide further examples without losing the effect sought.

It will be understood that the benefits and advantages described above may relate to one embodiment or may relate to several embodiments. It will further be understood that reference to ‘an’ item refer to one or more of those items.

The steps of the methods described herein may be carried out in any suitable order, or simultaneously where appropriate. Loop backs shown in the FIGS. demonstrate one possible manner in which steps may be repeated and alternative loop backs may be possible. Additionally, individual blocks may be deleted from any of the methods without departing from the spirit and scope of the subject matter described herein.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method comprising:
identifying statically allocated symbols in source code;
for each symbol identified, generating source code for a function to map between said symbol and a location associated with said symbol; and
compiling said source code and said generated source code.

2. A method according to claim 1, wherein said symbol comprises a symbol associated with a variable and wherein said location comprises a storage location for said variable.

3. A method according to claim 2, wherein said variable comprises one of a static local variable and a global variable.

4. A method according to claim 1, wherein said symbol comprises a symbol associated with a function and wherein said location comprises an address of an entry point for said function.

5. A method according to claim 1, further comprising:
generating an executable file from the compiled source code and generated source code.

6. A method according to claim 5, further comprising:
outputting said executable file to an embedded device.

7. A method according to claim 1, further comprising for each symbol identified:
generating associated data for said symbol; and
generating source code for a function to return said associated data,
and wherein compiling said source code and said generated source code comprises:
compiling said source code and said source code generated for a function to map between the symbol and a location associated with said symbol and said source code generated for a function to return said associated data.

8. A method according to claim 7, wherein said associated data comprises type data.

9. A method according to claim 8, wherein said type data comprises at least one of: a data type and a data size.

10. A method according to claim 1, wherein generating source code for a function to map between said symbol and a location associated with said symbol comprises:
generating a list of symbols and assigning each symbol on said list an index;
generating source code for a function to map between an index associated with said symbol and a location associated with said symbol; and
outputting said list.

11. A method according to claim 10, further comprising:
generating associated data for said symbol; and
generating source code for a function to return said associated data based on said index,
and wherein compiling said source code and said generated source code comprises:
compiling said source code and said source code generated for a function to map between an index associated with said symbol and a location associated with said symbol and said source code generated for a function to return said associated data based on said index.

12. A method of encoding symbol table information in an executable, the method comprising:
processing source code to identify any statically allocated symbols within said source code;
for each identified symbol, generating source code for a function to return a location associated with said symbol; and
compiling both said source code and all generated source code.

13. A method according to claim 12, wherein said statically allocated symbols comprise one or more of: static local variables, global variables and functions.

14. A method according to claim 13, wherein if a statically allocated symbol comprises a static local variable or a global variable, said location associated with the symbol comprises a storage location.

15. A method according to claim 13, wherein if a statically allocated symbol comprises a function, said location associated with the symbol comprises an address of an entry point for said function.

16. A method according to claim 12, further comprising, for each identified symbol:
generating additional data about said symbol; and
generating source code for a function to return said additional data.

17. A computer program comprising computer program code means adapted to perform the following steps when said program is run on a computer:
identify statically allocated symbols in source code;
for each symbol identified, generate source code for a function to map between the symbol and a location associated with said symbol; and
compile said source code and said generated source code.

18. A computer program as claimed in claim 17 embodied on a computer readable medium.
